(19) United States
(12) Patent Application Publication
(10) Pub. No.: US 2026/0276913 A1
(43) Pub. Date: Sep. 17, 2026

(54) OPTICAL CONNECTOR MODULE ASSEMBLY

(71) Applicant: Senko Advanced Components, Inc., Hudson, MA (US)

(72) Inventors: Yang CHEN, Thousand Oaks, CA (US); Robert Ryan VALLANCE, Newbury Park, CA (US); Armando MARTINEZ, Camarillo, CA (US)

(21) Appl. No.: 19/564,153

(22) Filed: Mar. 11, 2026

Related U.S. Application Data
(60) Provisional application No. 63/770,197, filed on Mar. 11, 2025.

(51) Int. Cl. G02B 6/42; G02B 6/36; G02B 6/38

(52) U.S. Cl. CPC G02B 6/4228; G02B 6/3616; G02B 6/3897; G02B 6/4249

(57) ABSTRACT

A connector assembly for demountable coupling to an array of receptacles associated with an array of optoelectronic units. An array of discrete connector units corresponding to the array of receptacles, each having a first coupling surface provided with first passive alignment features matching complementary second passive alignment features provided on a second coupling surface of a corresponding receptacle to form a demountable coupling between the first and second coupling surfaces. A frame detachably supporting the connector units with a clearance between the frame and corresponding connector units, permitting individual connector units to suspend or float with respect to the frame. A biasing member between a back cover and the connector units, providing a preload biasing each connector unit in a vertical direction perpendicular towards the first coupling surface. The connector units are independently movable to separately locate and coupled to a corresponding receptacle under the preload.

### 1. PRIORITY CLAIM

This application claims the priority of U.S. Provisional Patent Application No. 63/770,197 filed on Mar. 11, 2025, which is fully incorporated by reference as if fully set forth herein. Further, all publications noted below are fully incorporated by reference as if fully set forth herein.

### 2. FIELD OF THE INVENTION

The present invention relates to optical coupling optical fibers to optoelectronic components, and more particularly to demountable coupling high-density optical connectors to optoelectronic components (e.g., photonic integrated circuits (PICs)).

### 3. DESCRIPTION OF RELATED ART

Photonic integrated circuits (PICs) or integrated optical circuits are part of an emerging technology that uses light as a means of communication as opposed to an electric current. A PIC device integrates multiple photonic functions analogous to electronic chips, but providing functionalities for information signals imposed on optical wavelengths typically in the visible spectrum or near infrared 850 nm-1650 nm.

A PIC device (e.g., in the form of a silicon photonic chip package referred to as SiPIC) typically uses optical waveguides to route optical signals and/or interconnect various on-chip elements, such as optical switches, couplers, routers, splitters, multiplexers/demultiplexers, modulators, amplifiers, wavelength converters, optical-to-electrical (O/E) and electrical-to-optical (E/O) signal converters, etc. For proper operation, a PIC typically needs to efficiently couple light between multiple external optical fibers and on-chip waveguides with submicron positional accuracy to minimize optical insertion losses.

Development of photonic devices led to optical multichip modules (MCMs) being implemented to allow multiple integrated circuits and multiple PICs to be modularly incorporated into larger complex packages. This helps improve yields over conventional monolithic integrated circuits. A multi-chip module (MCM) consists of multiple integrated circuits that could be ASICs, CPUs, memory stacks or other ICs attached and packaged on a unifying common support (e.g., an organic PCB, silicon interposer, or glass interposer), which may include other discrete components, so that in use it can be treated as if it were one large circuit.

In recent years, co-packaged optics (CPO) have been developed, which are advanced MCMs involving specific, advanced types of photonic circuits alongside electronic integrated circuits (e.g., an electronic device, a PIC, a chip-on-wafer device, a silicon photonic IC, a photonic wafer, and/or the like). A CPO module typically involves placing at least one PIC, which handles optical functions, and at least one electronic integrated circuit (EIC), which manage the electrical signals, in close proximity to one or more processing unit (e.g., EIC in the form of a switch ASIC or CPU/GPU) on a shared substrate or interposer. “Optical engines” or “photonic engines” in the form of “chiplets” have been developed which typically consist of a PIC and an EIC in each chiplet. Optical engines can be placed directly next to the main processing unit. This heterogeneous integration of CPO achieves a system of chips in one package, bringing together optical engines and main processing unit to drastically reduce the electrical path length from centimeters to millimeters. By bringing the optics directly into the package closer with the main processing unit, CPO eliminates the need for traditional pluggable transceiver modules on an external front panel. Unlike pluggable transceivers, the optical engines are integrated onto the same substrate or package as the main processing unit, reducing power consumption and latency by shortening the distance electrical signals travel.

CPO technologies lead to a compact, high-efficiency multi-chip module that converts electrical signals from a main processing chip (like an ASIC or GPU) directly into optical signals for fiber transmission and in reverse converts optical signals from fiber input to electrical signals to be electronically processed. By replacing the relatively larger pluggable transceivers, CPO allows for more I/O ports within the same space. By increasing the density of optical I/O ports placed around a processing unit, a CPO can handle high-data-rate traffic in AI and machine learning applications. CPOs are being developed for deployment in high-density artificial intelligence (AI) data centers, which include XPUs and network switches.

To optically couple optical fibers to optical engines, an optical connector supporting optical fibers may be provided for each optical engine. However, this would require space for each optical connector and additional structural complexity in positioning each optical connector in optical alignment with the I/O ports of the corresponding optical engine. Increased density of optical I/O ports in a CPO introduces further challenges to achieving and maintaining submicron accuracy for optical coupling optical fibers to a CPO.

US Patent Publication No. US2024/0085633A1 (commonly assigned to the assignee of the present application and fully incorporated by reference herein) discloses configurable optical connector modules having a plurality of discrete optical benches supporting an array of optical fibers inputting/outputting optical signals. A carrier commonly supports the optical benches, with the optical benches fixedly mounted thereon in a desired spatial arrangement with the optical inputs/outputs of the optical benches matching optical inputs/outputs of corresponding external optoelectronic components in an MCM (e.g., by active alignment). The carrier includes passive alignment features (e.g., conforming to elastic averaging alignment coupling) for demountable coupling to the external components.

The large number of multifiber optical benches presents additional challenges to achieve and maintain optical alignment between the optical fibers and the optoelectronic components. The larger form factor of an optical connector module having a row of many multifiber-optical benches requires significant challenges to ensure positional accuracy of the optical benches to achieve and maintain acceptable optical alignment accuracy between the optical fibers across the entire row of optical benches and corresponding I/O ports of the optoelectronic components. Optical misalignments across the large form factor can lead to substantial optical insertion losses. Furthermore, a demountable optical connector module that is repeatedly mated and unmated with the optoelectronic components would require further considerations to achieve and maintain alignment accuracy. Moreover, once optical benches are permanently attached to the carrier in an optical connector module, a faulty fiber array associated with a particular optical bench cannot be effectively removed and replaced (i.e., separation of the optical bench from the carrier would be destructive.

US Patent Publication No. US2025/0284077A1 (commonly assigned to the assignee of the present application and fully incorporated by reference herein) discloses demountable coupling an optoelectronic component (e.g., a PIC) and an optical connector. A receptacle having an optical window is positioned in reference to optical I/O ports of the optoelectronic component. Matching demountable passive alignment features (e.g., conforming to elastic averaging alignment coupling) are provided on the facing surfaces between the receptacle and a cover plate of the optical connector.

What is needed is an improved high density optical connector module having an improved demountable mechanical coupling for connecting the optical connector module to multiple optoelectronic components in an MCM (e.g., CPO module), which improves tolerance, manufacturability, ease of assembly and use, easy of repair, demountable coupling efficiency and reliability at reduced costs.

### SUMMARY OF THE INVENTION

The present invention overcomes the drawbacks of earlier devices by providing an improved high density optical connector module comprising an assembly of an array of optical connector units for optically coupling to a corresponding array of external optoelectronic component units (e.g., a PIC or an optical engine including a PIC within an MCM (e.g., a CPO module)) via a corresponding array of receptacles. Receptacles with passive alignment demountable coupling features are aligned and positioned with respect to corresponding electronic components. Matching/complementary passive alignment demountable coupling features are provided on the surfaces of the connector units facing corresponding receptacles. The inventive optical connector module includes an improved demountable mechanical coupling of the array of connector units to an array of electronic components in an MCM (e.g., CPO), which improves tolerance, manufacturability, ease of assembly and use, easy of repair, demountable coupling efficiency and reliability at reduced costs.

In one aspect of the present invention, the array of connector units is detachably supported by a frame in the optical connector module, with clearance between the frame and corresponding connector units, in a manner permitting the individual connector units to independently suspend or “float” with respect to the frame. The connector units are movable in a horizontal plane parallel to the plane of the receptacle, relative to each other within the optical connector module. Each connector unit is not constrained by fixed attachment to the frame. Upon demountable coupling the optical connector module to the array of receptacles, each connector unit is allowed to separately locate on a corresponding receptacle (e.g., facilitated by one or more coarse alignment guides in sequence) and to demountably couple from the receptacle. As a result, misalignment considerations between the optical connector module and the array of optoelectronic units is confined to possible “local” misalignment to an extent associated to and limited to the relatively small footprint of relatively smaller form factor of a complementary pair of receptacle and connector unit, as opposed to potential cumulative misalignment of connector unit(s) if they were fixedly attached to the overall relatively large/wide footprint of relatively large form factor optical connector module.

In another aspect of the present invention, preload is provided within the optical connector module for the array of connector units in the optical connector module.

With the foregoing summary as introduction, the present invention may be further discussed below to support the features recited in the claims.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a schematic plan view of a co-packaged optics (CPO) module having receptacles for demountable coupling to the inventive optical connector module assembly.

FIGS. 2A and 2B illustrate demountable coupling on an optical connector module assembly to the edge of a CPO module, in accordance with one embodiment of the present invention.

FIGS. 3A to 3L illustrate an optical connector module assembly, in accordance with one embodiment of the present invention.

FIGS. 4A to 4F illustrate an optical connector module assembly, in accordance with a second embodiment of the present invention.

FIGS. 5A to 5F illustrate an optical connector module assembly, in accordance with another embodiment of the present invention.

FIGS. 6A to 6E illustrate an optical connector module assembly, in accordance with a further embodiment of the present invention.

### DETAILED DESCRIPTION OF THE PREFERRED EMBODIMENTS

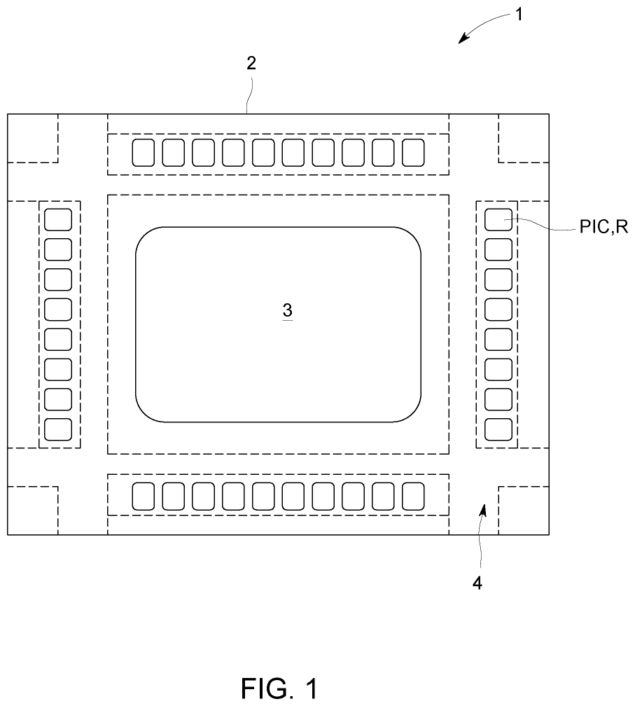

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention. The general configuration of the inventive optical connector module assembly will be discussed in reference to a co-packaged optics (CPO) module (hereinafter referred to simply as “CPO”) illustrated in FIG. 1, as a specific example of a multi-chip module (MCM).

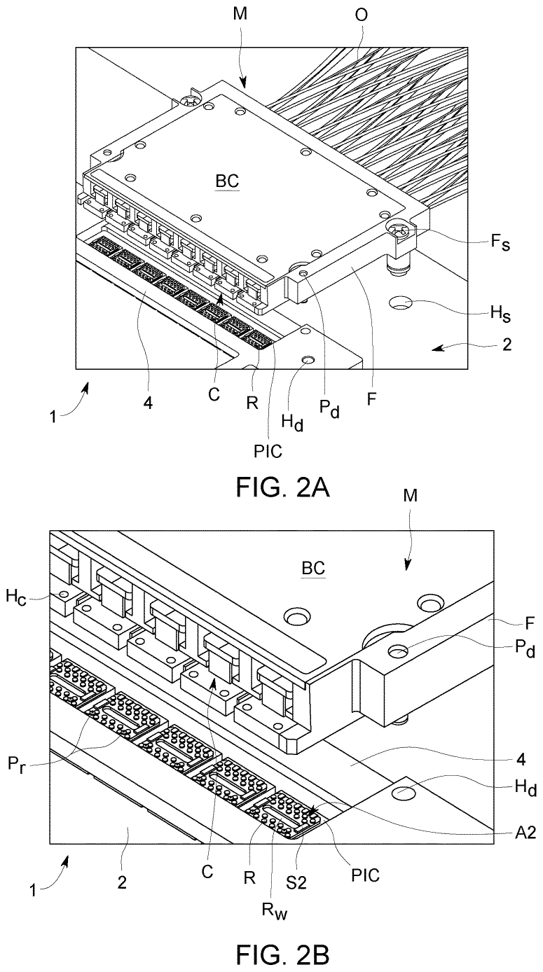

FIG. 1 is a schematic plan view of a CPO 1 to which the inventive optical connector module assembly (hereinafter referred to as “connector assembly”) is designed to demountable couple, in accordance with the embodiments discussed below in reference to FIGS. 2 to 6. As shown in FIG. 1, the CPO 1 may include a substrate 2, a main processing unit 3, and a plurality of optoelectronic components (hereinafter referred to as “optoelectronic units” (e.g., photonic integrated circuits PIC, optical engines and other types of optoelectronic components). Stiffeners 4 are attached to substrate 2 to improve and maintain integrity of the substrate from warpage and other external perturbations. As also shown in FIG. 1, the main processing unit 3 may be positioned on a central portion of the substrate 2, arrays of PICs may be positioned on a peripheral portion of the substrate 2. FIGS. 2A and 2B illustrate a representative linear array of PICs on one side of the peripheral portion of substrate 2. An optical fiber may be used to provide an optical signal from an external source or may be used to provide an optical signal from the PICs to an external receiver. The present invention provides a connector assembly demountably coupled by passive alignment (e.g., by kinematic, quasi-kinematic or elastic averaging coupling) to receptacles associated with the PICs for efficient coupling external optical fibers to PICs. In accordance with the present invention, an array of receptacles R is associated with and positioned in reference to each corresponding array of PICs.

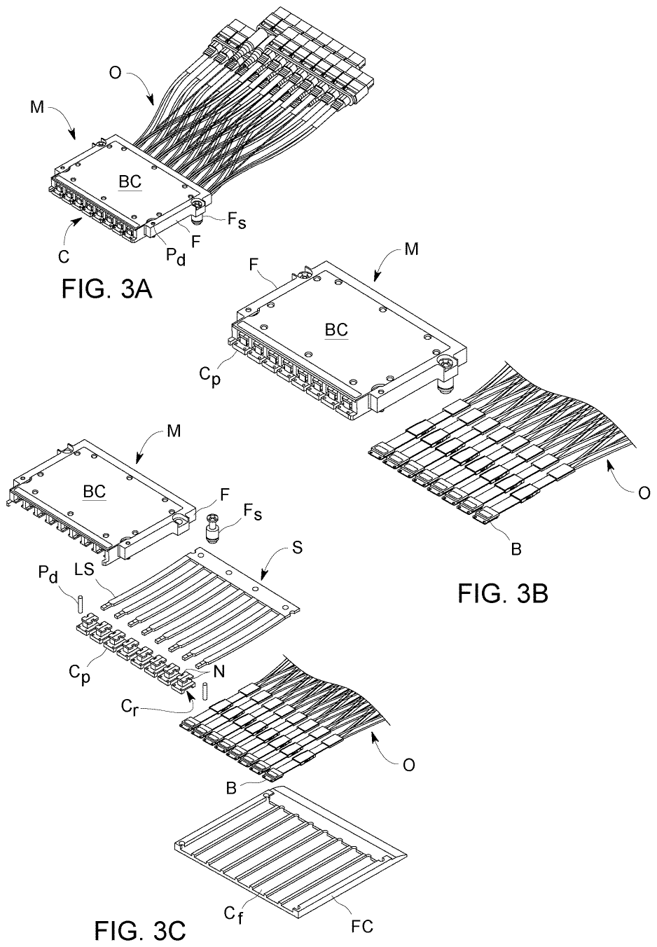

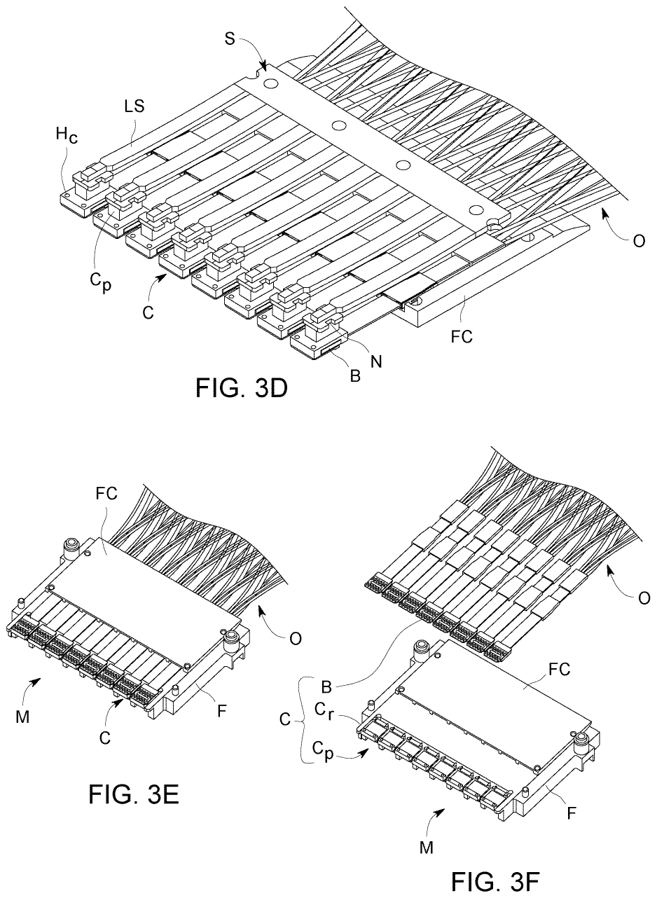

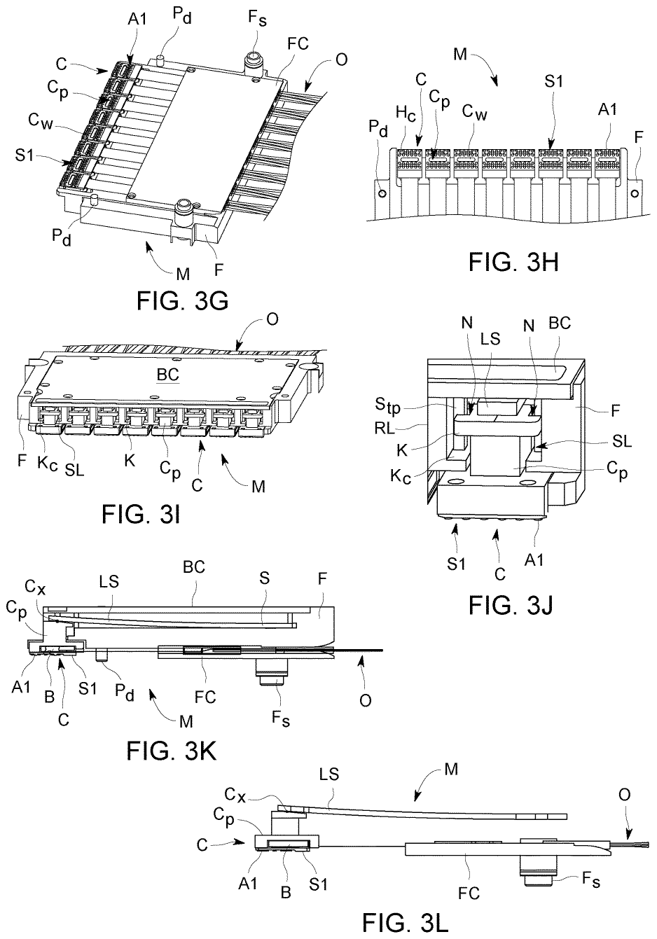

In the illustrated embodiment, the receptacles R are located at and bonded to (e.g., by epoxy, solder, etc.) the top of corresponding PICs. Each receptacle R includes passive alignment features A2 on coupling surface S2 of the receptacle in alignment with respect to the I/O ports of the PICs. As shown in FIG. 2B, a receptacle R including an optical path window RW are positioned on and in defined reference to the PIC, and each receptacle R may be configured to align its optical path window RW and optical path window CW (FIG. 3G) of a corresponding connector assembly M. The passive alignment features A2 are distributed about the optical path window W, to allow passage of optical signals to/from the connector units M and the I/O ports of the PICs.

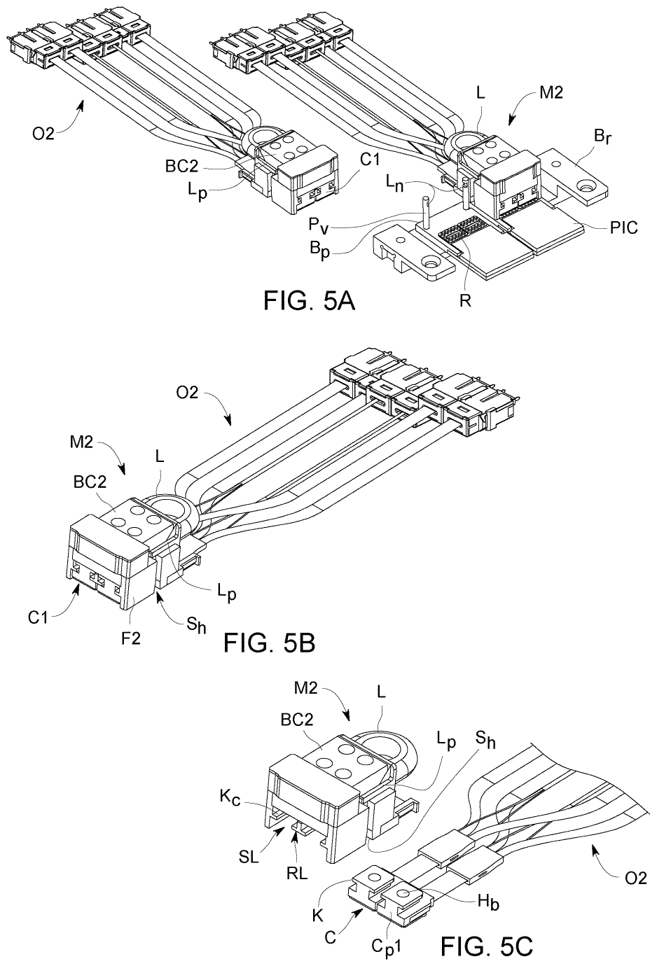

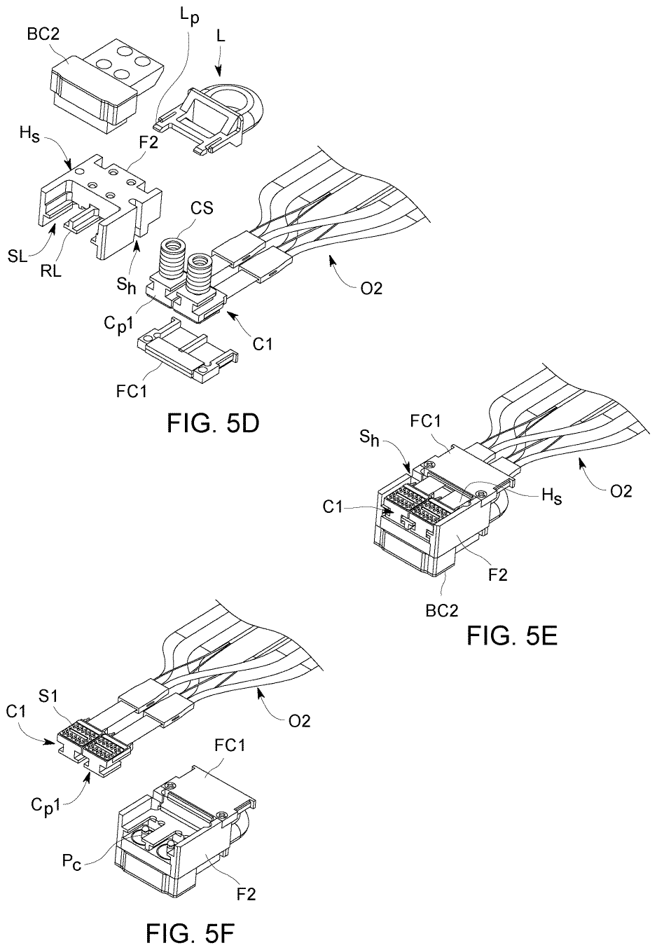

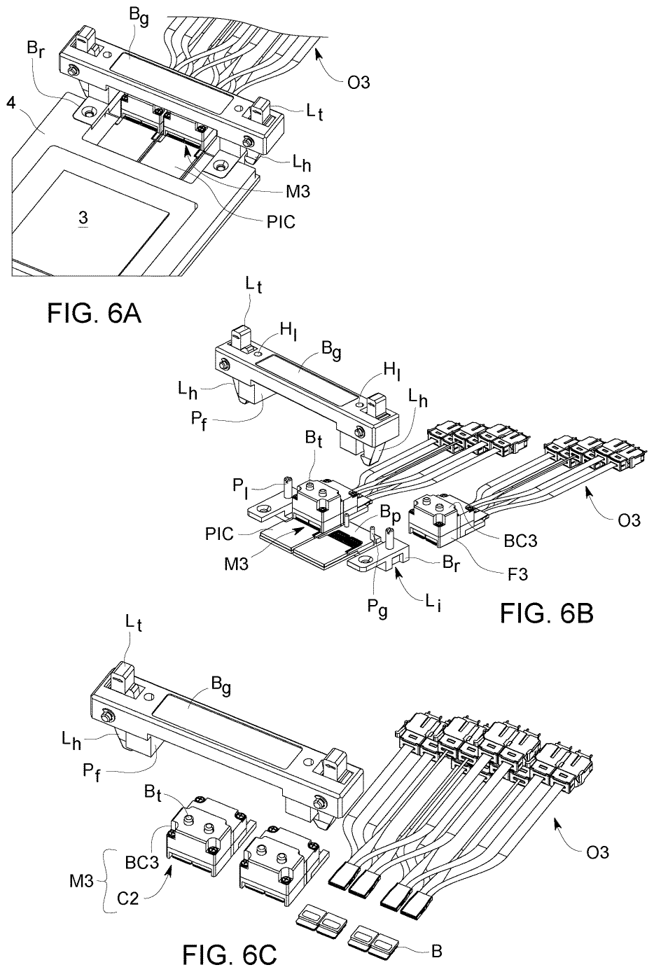

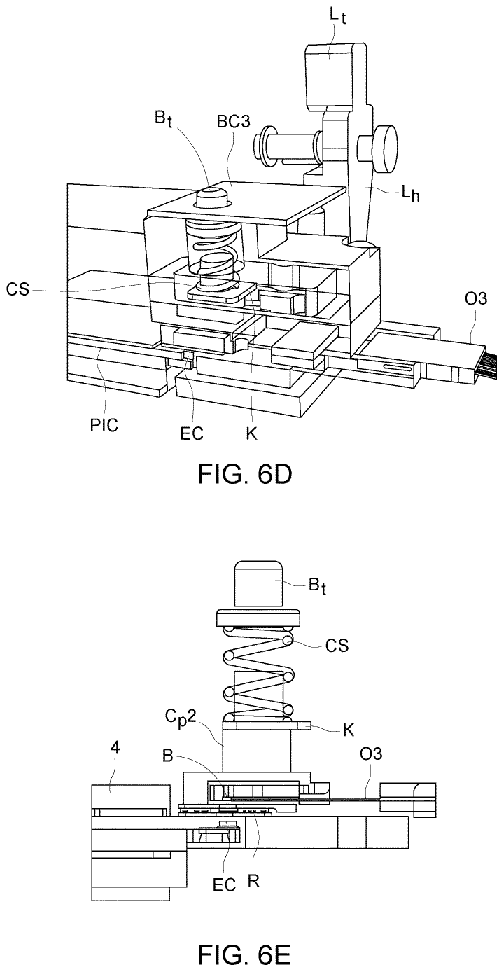

In the illustrated embodiment, each receptacle R is a separate component attached to a corresponding PIC. The receptacle R may be actively aligned to each PIC before bonding to the PIC. Alternatively, a receptacle can be integral in the top surface of a PIC. In further embodiments, e.g., illustrated in FIGS. 5 and 6 and discussed below, receptacles are located relative to edge couplers along the edge of PICs.

The receptacle R may be made of materials such as glass, silicon, metal, etc., formed by etching, stamping, etc. The features, structures, design considerations, making and applications of receptacles have been discussed in early patent documents published by the common assignee of the present invention (e.g., US Patent Publication Nos. 2025/0284077; 2016/0161686A1; US2024/0085633A1; 2024/0142722A1). References can be made to these earlier publications for further details and adoption for the present invention, which concepts when considered alone are not germane to the practice of the present invention.

Referring also to the embodiment illustrated in FIGS. 3A to 3L, the connector assembly M for demountable coupling to the array of receptacles R associated with the array of PICs, comprises: an array of discrete connector units C corresponding to the array of receptacles R, wherein the connector units C each comprising an optical bench B supporting an array of optical fibers O for inputting/outputting optical signals to/from corresponding array of I/O ports of a corresponding PIC, wherein each connector unit C comprises a first coupling surface S1 provided with first passive alignment features A1 matching complementary second passive alignment features A2 provided on a second coupling surface S2 of a corresponding receptacle R, and wherein removably mating the first passive alignment features A1 and the second passive alignment features A2 forms a demountable coupling between the first coupling surface S1 and the second coupling surface S2. A frame F detachably supports the connector units C with a desired clearance between frame F and corresponding connector units C, in a manner permitting individual connector units to suspend or float with respect to the frame F. A back cover BC is attached to frame F, having a portion extending over the array of connector units C. A front cover FC attached to the bottom of the frame F covers the fiber arrays O. A biasing member S between the portion of the back cover BC and the connector units, providing a preload biases each connector unit C in a vertical direction perpendicular towards the first and second coupling surfaces S1 and S2. The back cover BC is attached to frame F, with the biasing member S disposed between the back cover and the connector units. The biasing member S provides independent preloads biasing the connector units C independent of one another. In the embodiment, biasing member S is implemented by an array of spring members in the form of leaf springs LS cantilevered between the frame F and the back cover BC. Further embodiments are illustrated and discussed below which are implemented with coil springs and elastomeric springs.

In the illustrated embodiment in FIGS. 3A to 3L, each connector unit C comprises an optical bench having a body B supporting the optical fibers O substantially parallel to the first coupling surface S1, wherein the optical bench B comprises a linear array of structured optical surfaces (e.g., free form reflective surfaces that create concave optical surfaces, internally reflective surfaces, etc.) defined in reference/relation to the first passive alignment features and optically aligned with the respective optical fibers, and wherein the array of structured optical surfaces direct optical signals as input/output of connector unit C. The first coupling surface S1 at the bottom surface of the OB is provided with the first passive alignment features A1. In the illustrated embodiment, first coupling surface S1 is defined by a cover plate CP on the body of optical bench OB, which defines optical path window CW through which optical signals are transmitted to/from the optical fibers in the fiber array O. The features, structures, design considerations, making and deployments of optical benches have been discussed in early patent documents published by the common assignee of the present invention (e.g., US Patent Publication Nos. 2025/0284077; 20 16/0161686A1; US2024/0085633A1; 2024/0142722A1; and publications referenced therein). References can be made to these earlier publications for further details and adoption for the present invention, which concepts when considered alone are not germane to the practice of the present invention.

In alternate embodiments, optical benches of other configurations may be adopted without departing from the scope and spirit of the present invention. The inventive concept of deploying floating connector units withing an optical connector assembly could adopt other configurations of optical benches that include a substrate serving as a rigid platform for aligning and mounting multiple, discrete optical fibers, and any required optical components (e.g., optical surfaces, lenses, etc.) to facilitate transmission of optical signals to/from the optical fibers.

The complementary first and second passive alignment features on the first and second coupling surfaces correspond to at least one of kinematic coupling, quasi-kinematic coupling, and elastic averaging coupling. In the illustrated embodiment, the first and second passive alignment features A1 and F2 conform to elastic averaging coupling, comprising a first two-dimensional array of alignment features A1 on the first coupling surface S1 of the connector unit C, and a second two-dimensional array of alignment features A2 on the second coupling surface S2 of the receptacle, wherein the first coupling surface S1 is removably attachable to the second coupling surface S2 to define a demountable coupling, with the first array of alignment features A1 against the second array of alignment features A2 to define an elastic averaging coupling, thereby passively aligning and demountably coupling the first coupling surface S1 to the second coupling surface S2. The characteristics and benefits of deploying a demountable elastic averaging coupling for optical connectors have been extensively discussed in assignee's earlier patent publications (e.g., US Patent Publication Nos. 2024/0085633A1; 2024/0142722A1; 2016/0161686A1 and U.S. Pat. No. 11,500,166B2; and publications referenced therein) disclose elastic averaging features suitable for connection of an optical connector to receptacle and other support foundations. References can be made to these earlier publications for further details and adoption for the present invention, which concepts when considered alone are not germane to the practice of the present invention.

In accordance with the present invention, the clearance between the frame and each connector unit C is within a desired tolerance range allowing the connector unit C to be movable relative to the frame F with degrees of freedom including translations along vertical axis (Z-axis) and horizontal axes in a horizontal plane parallel to the second coupling surface of the receptacle (Y-axis along the optical axis of the optical fibers O and X-axis orthogonal to the Y-axis) and rotation about vertical axis (Z-axis) (and further to some extent about the horizontal axes).

The frame F comprises an array of slots SL corresponding to the array of connector units C, wherein each slot SL defines a space detachably and slidably receiving a corresponding connector unit C with a desired clearance to allow the connector units to be moveable relative to the slots SL.

In the illustrated embodiment, the slots SL and the connector units C are configured with limit guide features to limit the extent of movements of the connector units C with respect to the corresponding slots SL. More clearly shown in FIG. 3J, each connector unit C comprises a cap Cp at a top portion thereof opposite to the first coupling surface S1, wherein a top of the cap Cp is subject to preload biasing by the biasing member S. The cap Cp is attached to the top of the body of the optical bench B; the cap Cp has a base with a bottom recess Cr receiving and bonding to the optical bench B (more clearly shown in exploded view in FIG. 3C and bottom view of cap Cp in FIG. 3F). Frame F comprises a plurality of rails RL, wherein each slot SL is defined by a facing pair of rails RL extending from frame F defining the central space of the slot SL. The frame F supports each connector unit via a corresponding pair of rails RL and cap Cp. The cap Cp detachably and slidably supported by the corresponding pair of rails RL with a desired clearance between the rails RL and corresponding cap Cp to allow the respective connector units C to be moveable relative to the slot SL. The limit guide features include complementary keys K and key channels KC provided along the rails RL and corresponding cap. In the illustrated embodiment depicted in FIG. 3J, wherein each rail RL has a key K or a key channel KC extending along the rail RL, and the cap Cp has a complementary key channel KC or key K on both opposite sides of the cap Cp, wherein each cap Cp is detachably and slidably received in a corresponding slot SL with the keys K or key channels KC on the rails slidably engaging the corresponding key channels KC or keys K on the sides of the cap Cp. In the illustrated embodiment, key K is provided along the cap Cp of the connector unit C, and key channels KC are provided along the rails RL. This complementary key and key channel features may be reversed between the cap Cp and the rails RL. In this particular embodiment, the cap Cp has an overall generally I-shaped section and the key channels KC have a generally C-shaped section defined between the rails RL and the backplate BC. The top horizontal ends of the “I” of the cap Cp extend into and are loosely received in the recesses in the key channels KC. As can be appreciated, the cap Cp can move vertically, horizontally in a plane, and about the vertical axis, to an extent limited by the guide features.

Furthermore, the limit guide features may further include at least a plurality of stops Stp corresponding to the array of connector units C. Referring to FIGS. 3C and 3J, each stop Stp extends from the back cover BC to be received in a corresponding complementary indentation or notch N provided at the top horizontal ends of each cap Cp. The stops Stp limit the translational movements of the caps Cp along the optical axis of optical fibers O (Y-axis), thereby limiting the extent the caps Cp can slide out of the slot SL (key channel KC).

In a further embodiment, referring to FIGS. 3K and 3L, the cap Cp is configured to center the biasing along the thermal center of the first passive alignment features A1 on the coupling surface S1. In this connection, the contact area between the top of each cap Cp and biasing member S (in this case a cantilevered leaf spring SL) is reduced to a minimum (e.g., to a point contact), with such contact generally aligned with a centerline of the first passive alignment features A1 on the first coupling surface S1 of the connector unit C. This would reduce physical constraints on the cap Cp (and hence the connector unit C) in the horizontal plane, to allow connector unit C to more freely move in the horizontal plane to couple to corresponding receptacle R (an important consideration for elastic averaging coupling). To facilitate such reduced area or point contact, the top of each cap Cp is configured with a convex surface profile Cx (e.g., a crowned surface profile, at least one-dimensional, or preferably two-dimensional), with a contact area or point (i.e., highest point) of the cap Cp generally aligned with a thermal centerline of the first passive alignment features A1 on the first coupling surface S1 of the connector unit C.

The characteristics and benefits of a thermal centerline demountable elastic averaging coupling for optical connectors have been extensively discussed in assignee's earlier patent publication US Patent Publication No. 2026/0050132A1 (and publications referenced therein). References can be made to the earlier publications for further details and adoption for the present invention.

To assemble the connector assembly M, the connector units are each bonded to a base of caps Cp (e.g., via glue, solder, or laser welding). Fiber arrays O are arranged on channels Cf provided on the inside of front cover FC (FIG. 3C), which is then attached to frame F. Fiber arrays O can be extended forward slightly to allow the caps Cp to be received from the front of corresponding slots SL and then extended backward to engage the caps Cp. The biasing member S is placed within frame F, with leaf spring members LS pressed against top of caps Cp. The back cover is attached to frame F (e.g., using screws) to keep the biasing member S in a biased state (i.e., with leaf springs LS bent under compression) throughout use of the connector assembly M. The stops Stp under back cover BC extend into the notches at the top of the caps Cp. Consequently, combination of limit guide features (i.e., key K/key channel KC and stops Stp/notches N) retain the caps Cp within corresponding slots SL, with movements of the caps Cp with limits prescribed by this combination of limit guide features.

The complementary passive alignment features A1 and A2 provides repeatable, fine alignment between corresponding pair of connector unit C and receptacle R. In addition, coarse alignment features may be provided to facilitate initial (first level coarse alignment) positioning of connector assembly M and connector units C with respect to the receptacles R. Frame F comprises one or more sets of coarse alignment guide features (e.g., dowel pins Pd; FIGS. 2A, 2B, 3C, 3G, 3H, 3K), which are structured to loosely engage (with clearance) with complementary guide holes Hd (FIGS. 2A and 2B) on the substrate 2 to guide initial physical positioning of the connector module M to the receptacles R. More than one set of coarse alignment guide features may be provided on frame F and substrate 2.

In addition, connector units C further comprise a second level coarse alignment guide features structured to facilitate guiding the respective connector units C to mate with the corresponding receptacle R at the interfacing first and second passive alignment features A1 and A2. In the illustrated embodiments, holes Hc are provided at the front of the base of the caps Cp for relatively loosely engaging complementary posts Pr extending on coupling surface S2 of receptacles R, thereby roughly, initially guiding connector units C to receptacles R. Accordingly, conforming to a sequence of coarse alignments, when connector assembly M is initially placed onto receptacles R, dowel pins Pd first engage hole Hd on frame F, then hole Hc on base of cap Cp of connector unit C relatively loosely engage posts Pr on receptacles R.

Upon first and second levels of coarse alignment and placement of the connector assembly M with respect to the optoelectronic units PIC on substrate 2 with connector units C over the array of receptacles R, the connector units C are independently movable to separately locate and demountably coupled to a corresponding receptacle R under the preload S to mate or seat the first and second passive alignment features A1 and A2 on facing first and second coupling surfaces S1 and S2, thereby achieving final fine alignment by passively aligning each connector unit with a corresponding receptacle.

Upon completing sequential coarse alignment, and final fine alignment of the first and second coupling surfaces S1 and S2, fasteners Fs (e.g., screws) are applied to complementary holes Hd on substrate 2 to securely by detachably maintain the connector assembly M on the substrate 2. In this locked position, the connector assembly M is securely positioned with respect to the substrate 2 and hence the PICs thereon, and the biasing member S within the connector assembly M continues to maintain a bias on first coupling surfaces S1 against second coupling surfaces S2 of receptacles R, to maintain passive demountable coupling between connector units C and receptacles R.

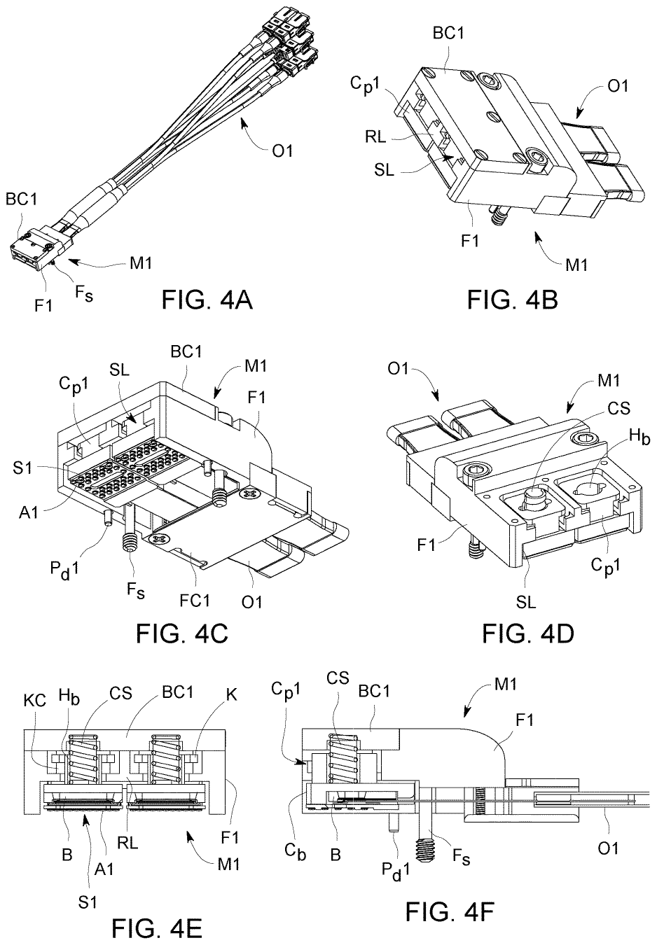

FIGS. 4A to 4F illustrate an alternate embodiment of an inventive connector assembly M1. This embodiment is quite similar to the previous embodiment. The major differences include a lesser number of connector units C1 (small bundle of fiber array O1) and modifications adopting a biasing member S1 that is in the form of coil springs. Otherwise, the structure of the connector assembly M1 is generally similar to that of the connector assembly M in the previous embodiment. Two connector units C1 having similar optical benches B, and modified caps Cp1 are supported in similar slots SL with similar rails RL defined in frame F1. Each optical caps Cp1 has a top portion modified with a blind hole Hb along the vertical (Z) axis, to receive a cylindrical coil spring CS. Coil spring CS compressed between the back cover BC1 and connector unit C presses on bottom of blind hole, e.g., against base Cb of cap Cp1, as more clearly shown in the section views in FIGS. 4E and 4F. The caps Cp1 have similar top horizontal keys K for engaging key channels KC in the slots SL. While not shown in the drawings, a concentric post may be provided at the center of the blind hole Hb to guide the coil spring CS so as to reduce wobble and/or prevent warping of the coil spring CS. (See, also the connector assembly M2 in FIG. 5.) This post may depend from back cover BC1 or extend upwards from base Cb of cap Cb1.

The back cover BC1 is modified to cover frame F1 to accommodate the additional height of the coil spring CS. Compared to the previous embodiment in which cantilevered leaf springs are adopted, this embodiment adopting coil springs CS has a relatively larger height form factor, but a relatively smaller footprint (smaller planar dimension) without the need to accommodate cantilevering leaf springs LS as in the previous embodiment. Similar level one and level two coarse alignment features may be provided; for example, dowel pin Pd1 at the bottom of frame F1 for guiding engagement with a complementary hole in supporting substrate or stiffener (not shown; e.g., in the CPO 1 shown in FIG. 1)), and holes Hc provided on front of base of cap Cp1 for guiding engagement with posts on receptacles R). Screws Fs1 are provided to fasten connector assembly M1 to support substrate or stiffener.

FIGS. 5A to 5F illustrate another embodiment of an inventive connector assembly M2. In this embodiment, each connector assembly M2 is also configured to house two connector units C2. This embodiment shares general similar features of the embodiment of FIG. 4, with the exception of the back cover BC2 and the attachment thereof in the presence of an edge coupler EC in this embodiment. The characteristics and deployment of edge couplers for optical connectors have been extensively discussed in assignee's earlier patent publication U.S. Pat. No. 11,022,755 (and publications referenced therein). References can be made to the earlier publications for further details and adoption for the present invention, which concepts when considered alone are not germane to the practice of the present invention.

Otherwise, the structure of the connector assembly M2 is generally similar to that of the connector assembly M1 in the previous embodiment. Two connector units C1 having substantially similar optical benches B and caps Cp1 are supported in similar slots SL with similar rails RL defined in frame F2. Each cap Cp1 has a top portion modified with a blind hole Hb along the vertical (Z) axis, to receive a cylindrical coil spring CS. Coil spring CS compressed between back cover BC2 and connector unit C presses on bottom of blind hole, e.g., against base Cb of cap Cp1 (more clearly shown in the section views in FIGS. 4E and 4F). The caps Cp1 have similar top horizontal keys K for engaging key channels KC in the slots SL. In this embodiment, a concentric center post Pc is provided at the center of the blind hole Hb to guide the coil spring CS so as to reduce wobble and/or prevent warping of the coil spring CS. This post depends from back cover BC2 but alternately can extend upwards from base Cb of cap Cp1.

In this embodiment, optical path window RW of receptacle R is aligned with the optical ports of the edge coupler EC, as the input/output optical signals between connector unit C1 and edge coupler EC is transmitted through the optical path window RW in receptacle R. See, also sectional view of embodiment of FIG. 6E. A platform Bp is positioned at edge of row of optoelectronic units PICs, e.g., by attaching to a substrate (e.g., of the CPO 1 shown in FIG. 1). Edge coupler EC is positioned on bracket Br, or within a space defined in bracket Br, under the platform Bp in optical alignment with I/O ports of PIC.

The frame F2 has a vertical slot Sv adjacent one side and a vertical through hole Hs adjacent opposite side. When the connector assembly M2 is initially placed/mounted onto the bracket Br, vertical latch/guide posts Pv extending from the bracket Br provide guiding engagement with slot Sv and hole Hs on frame F2, thus provide a first level of coarse alignment. Vertical hole Hs in frame F2 allows limit clearance for the post Sv. However, the open slot Sh allows more lateral clearance in the X direction.

The back cover BC2 is modified to cover frame F2 to accommodate locking latch L to secure frame F2 of connector assembly M2 on the support bracket Br. Referring to FIG. 5D, latch L has spring prongs Lp with tips that are configured to engage complementary latch notch Ln on each post Pv. Notches Ln are inward facing each other, for receiving the outward biased tip portions of prongs Lp when latch L is pushed towards the frame F2 and prongs Lp ride on the sides of frame F2. Back cover BC2 can be screwed onto F2 to maintain the coil spring CS under compression.

While not shown in FIGS. 5A to 5F, similar level two coarse alignment features may be provided (e.g., coarse alignment holes may be provided at front of base of cap Cp1 by including a base flange, not shown) for guiding engagement with complementary posts on receptacles R.

FIGS. 6A to 6E illustrate a further embodiment of an inventive connector assembly M3. In this embodiment, each connector assembly M3 is also configured to house two connector units C2 for demountable coupling to receptacles R in relation to edge couplers EC. In this embodiment, the back cover BC3 biases coil spring CS in a biasing structure different from the earlier embodiments.

In this embodiment, as in the preceding embodiment, optical path window RW of receptacle R is aligned with the optical ports of the edge coupler EC, as the input/output optical signals between connector unit C2 and edge coupler EC is transmitted through the optical path window RW in receptacle R. A bracket Br is positioned at edge of row of optoelectronic units PICs, e.g., by attaching to a substrate (e.g., of the CPO 1 shown in FIG. 1). Edge coupler EC is positioned on bracket Br, or within a space defined in bracket Br, in optical alignment with I/O ports of PIC.

In this embodiment, the structure of the connector assembly M3 is generally similar to that of the connector assembly M2 in the previous embodiment. Two connector units C2 having similar optical benches B, and caps Cp2 are supported in similar slots SL with similar rails RL defined in frame F3. Cp2 may have similar top horizontal keys K for engaging key channels KC in the slots SL. Each cap Cp2 has a bottom portion that can be similar to the previous embodiment. In this embodiment, instead of a blind hole, the top portion of the caps Cp2 is modified with an upward extending cylindrical post Pu along the vertical (Z) axis. The coil spring CS is deployed around this post Pu. The upper end of the coil spring CS supports a button Bt, which extends though a hole in the back cover BC3. Button Bt exposed above the back cover BC3 is used for compressing the coil spring CS when the bridge Bg presses on button Bt.

Bridge Bg is used to latch both connector assemblies M3 onto the support bracket Br. Posts Pl near the side edges of the bracket Br extend upwards and are received by the complementary holes Hl in the feet Pf of the bridge Bg. As shown in FIG. 6B, two ends of the longitudinal bridge are provided with a pivotable latch Lh having a hook at its bottom end. Complementary undercut indentations Li are provided at the side edges of the support bracket Br, which receive the hooks of the latches Lh (more clearly shown in FIG. 6A). In this latched configuration, bridge Bg presses on each button Bt, which in turn compresses coil spring CS to exert a bias against bottom portion of cap Cp2. The latches Lh can be unhooked by pivoting the hooks outwards with tabs Lt at the upper ends of latches Lh, to remove bridge Br from the post Pl to allow demounting a connector assembly M3 from corresponding receptacle R. As can be appreciated, this embodiment allows for demounting the connector assembly M3 without requiring any hand tool, by simply squeezing tabs Lt towards each other.

Vertical guide posts Pg extending from the bracket Br provides a first level of coarse alignment. When the connector assembly M3 is initially placed/mounted onto the bracket Br. Vertical guide posts Pg extending from the bracket Br provide guiding engagement with matching holes under the frame F3 (not shown), thus provide a first level of coarse alignment.

While not shown in FIGS. 6A to 6F, similar level two coarse alignment features (e.g., coarse alignment holes may be provided at front of base of cap Cp2 by providing a base flange, not shown) for guiding engagement with posts on receptacles R.

Based on the above disclosed embodiments, it can be realized that the present invention achieves at least the following advantages:
(a) In all embodiments, the connector units are in a suspended, floating state, which is particularly useful for kinematic, quasi-kinematic, and elastic averaging couplings, without over constraining movements of the connector units.
(b) The embodiment incorporating leaf springs result in connector assemblies that are low profile.
(c) Built-in preload biasing of connector units can accommodate thermal induced dimensional variations.
(d) Connector assemblies of large form factors may be achieved with large number of connector units, with individual connector units independently floating/suspended can independently align and maintain alignment. Misalignment considerations between the array of connector units in the optical connector assembly and the array of optoelectronic units is confined to possible “local” misalignment to an extent associated to and limited to the relatively small footprint of relatively smaller form factor of a complementary pair of receptacle and connector unit, as opposed to potential cumulative misalignment of a linear array of connector units if they were fixedly attached to the overall relatively large/wide footprint of relatively large form factor connector assembly.
(e) Individual connector units may be removed along with associate fiber array from the connector assembly and easily replaced, if necessary, without wasting the remaining connector assembly components. The connector units are not bonded within the slots and/or to the frame of the connector assemblies.
(f) The fiber array subassemblies including optical benches are pretested and supplied as “known good cables” that reduce handling at the assembly location for connector assemblies, or at field locations. The fiber array subassemblies undergo a series of screening tests to determine “known good cables” before forwarding for use in connector assemblies.
(g) During the service life of the connector assemblies, a faulty fiber array subassembly is replaceable with a good subassembly to extend the overall service life of the significantly more expensive connector assemblies.
(h) Sequential coarse alignment features provide at least one or more levels of coarse alignment of the connector assembly prior to the final fine alignment of the connector unit to the receptacle.
(i) If the connector assembly is deployed for use with CPO, the foregoing flexibility of the inventive connector assembly reduces potential costs of having to replace an entire CPO when prior art connector assemblies are otherwise permanently attached to the CPO substrate.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

1. An optical connector module assembly for demountable coupling to an array of
receptacles associated with an array of optoelectronic units, comprising:
an array of discrete connector units corresponding to the array of receptacles, wherein the connector units each comprising an optical bench supporting an array of optical fibers for inputting/outputting optical signals to/from corresponding array of I/O ports of a corresponding optoelectronic unit, wherein each connector unit comprises a first coupling surface provided with first passive alignment features matching complementary second passive alignment features provided on a second coupling surface of a corresponding receptacle, and wherein removably mating the first passive alignment features and the second passive alignment features forms a demountable coupling between the first coupling surface and the second coupling surface,
a frame detachably supporting the connector units with a desired clearance between the frame and corresponding connector units, in a manner permitting individual connector units to suspend or float with respect to the frame,
a back cover attached to the frame, having a portion extending over the array of connector units;
a biasing member between the portion of the back cover and the connector units, providing a preload biasing each connector unit in a vertical direction perpendicular towards the first coupling surface;
wherein upon secured placement of the assembled optical connector module (e.g., securing onto a substrate) with respect to the optoelectronic units (e.g., on a substrate) with the connector units over the array of receptacles, the connector units are independently movable to separately locate and demountably coupled to a corresponding receptacle under the preload to mate the first and second passive alignment features on facing first and second coupling surface, thereby passively aligning each connector unit and a corresponding receptacle.
